(19) United States
(12) Patent Application Publication
(10) Pub. No.: US 2013/0236718 A1
(43) Pub. Date: Sep. 12, 2013

(54) Pressure Sensitive Adhesives Containing A Cyclic Phosphonate Ester Flame Retardant

(71) Applicants: Joern Buettner, Neuss (DE); Eumi Pyun, Austin, TX (US); Anthony R. Plepys, Austin, TX (US); Lisa S. Lim, Sandy, UT (US); Francois C. D'Haese, Antwerp (BE); Tobias Pick, Korschenbroich (DE)

(72) Inventors: Joern Buettner, Neuss (DE); Eumi Pyun, Austin, TX (US); Anthony R. Plepys, Austin, TX (US); Lisa S. Lim, Sandy, UT (US); Francois C. D'Haese, Antwerp (BE); Tobias Pick, Korschenbroich (DE)

(73) Assignee: 3M Innovative Properties Company, St. Paul, MN (US)

(21) Appl. No.: 13/882,555

(22) PCT Filed: Mar. 11, 2011
(86) PCT No.: PCT/US11/28137

§ 371 Date: May 24, 2013

Related U.S. Application Data
(60) Provisional application No. 61/408,692, filed on Nov. 1, 2010.

(51) Int. Cl. C09J 133/06; B32B 7/12; C09J 7/02

(52) U.S. Cl. CPC C09J 133/064; C09J 7/0217; B32B 7/12
USPC 428/317.3; 524/108; 428/355 AC; 428/354

(57) ABSTRACT

Pressure sensitive adhesives containing a cyclic phosphonate ester are described. Methods of preparing such adhesives and articles comprising such adhesives are also described.

### FIELD

The present disclosure relates to flame retardant pressure sensitive adhesives. In particular, pressure sensitive adhesives containing a relatively low amount of a cyclic phosphonate ester flame retardant.

### BACKGROUND

Generally, pressure sensitive adhesives are well-known and used in a wide variety of applications. Acrylic adhesives are a common class of pressure sensitive adhesive. However, acrylic adhesives may be flammable and can contribute to the formation of combustion gasses during a fire. As adhesive tapes are used widely in household, industrial, and electronic applications, there is a need to reduce or eliminate any contributions of adhesive tapes to the fire load.

Flame retardants have been added to adhesives including acrylic adhesives. For example, halogenated flame retardants such as polybrominated biphenylethers have been very effective. However, halogenated materials are being restricted or even banned due to environmental and health concerns associated with some such materials and there is a desire to find alternative flame retardants.

Other flame retardants such as metal hydroxides and red phosphorous have been used; however, typically these materials must be used at high concentrations in order to achieve the desired level of flame retardancy. In many cases, the required loadings of such flame retardants results in an unacceptable decrease in the mechanical and adhesive properties of the pressure sensitive adhesive.

Phosphites, phosphates, and phosphonates have also been used as flame retardants. For example, flame retardant radiation curable compositions containing both a cyclic phosphonate and at least one other flame retardant selected from phosphorous derivates different from cyclic phosphonates are described in EP 2 154 191 A1. EP 2 154 191 A1 exemplifies films that achieve UL 94 classification of V1 or V0, but only at relatively high loadings of the cyclic phosphonate flame retardant (at least 17 weight percent) in combination with relatively high loadings of another phosphorous-derivative flame retardant (at least 15 weight %).

There remains a need to identify non-halogenated flame retardants for pressure sensitive adhesive compositions. In addition, there is a need to provide acceptable flame retardant properties at sufficiently low loading levels of the flame retardant so as to avoid unacceptable reductions in pressure sensitive adhesive performance.

### SUMMARY

Briefly, in one aspect, the present disclosure provides a flame retardant pressure sensitive adhesive comprising a polymeric component comprising an acrylic pressure sensitive adhesive and a flame retardant comprising at least one cyclic phosphonate ester, wherein the flame retardant comprises less than 2 parts by weight of a phosphorous containing flame retardant other than the cyclic phosphonate ester.

In some embodiments, the total amount of flame retardant is no greater than 20 parts by weight per 100 parts by weight of the polymeric component, e.g., between 3 and 15 parts by weight, inclusive, per 100 parts by weight of the polymeric component, or even between 3 and 6 parts by weight, inclusive, per 100 parts by weight of the polymeric component.

In another aspect, the present disclosure provides a flame retardant pressure sensitive adhesive comprising a polymeric component comprising an acrylic pressure sensitive adhesive and a flame retardant comprising at least one cyclic phosphonate ester, wherein the total amount of cyclic phosphonate ester is no greater than 6 parts by weight per 100 parts by weight of the polymeric component. In some embodiments, the total amount of cyclic phosphonate ester is no greater than 6 parts by weight per 100 parts by weight of the polymeric component, e.g., between 3 and 6 parts by weight, inclusive, per 100 parts by weight of the polymeric component.

In some embodiments of any of these aspects of the present disclosure, the flame retardant comprises at least one cyclic phosphonate ester having the formula:

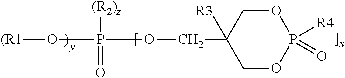

wherein R1 and R2 are independently selected from the group consisting of a C1 to C8 alkyl and a phenyl, wherein the alkyl and/or phenyl group may be substituted with at least one hydroxyl, hydroxyalkyl, or phenoxyalkyl, group; R3 and R4 are independently selected from the group consisting of C1 to C4 alkyl; x is 1, 2, or 3; y is 0, 1, or 2; and z is 0 or 1; wherein the sum of x, y, and z is equal to 3.

In some embodiments, the cyclic phosphonate ester comprises at least one of

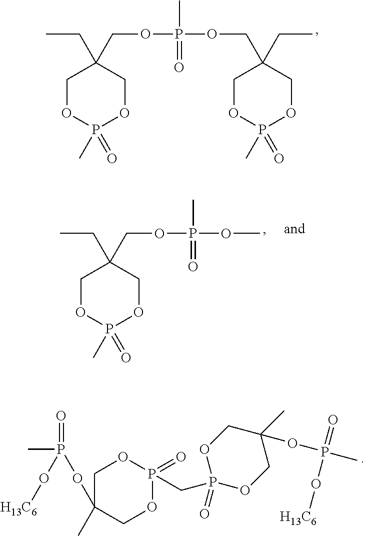

In another aspect, the present disclosure provides adhesive articles comprising a first substrate and a first adhesive adhered to a first major surface of the first substrate, wherein the first adhesive comprises the flame retardant pressure sensitive adhesives of the present disclosure. In some embodiments, the adhesive article further comprises a second adhesive wherein the first adhesive and the second adhesive are independently selected. In some embodiments, the adhesive article further comprising a second substrate adhered to the first adhesive such that the first adhesive is located between the first substrate and the second substrate. In some embodiments, at least one substrate comprises a polymeric film, e.g., polyester film. In some embodiments, at least one substrate comprises a foam, e.g., an adhesive foam.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 illustrates an exemplary adhesive article according to some embodiments of the present invention, the article having a “Spacer” configuration.

FIG. 2 illustrates an exemplary adhesive article according to some embodiments of the present invention, the article having a “Sandwich” configuration.

### DETAILED DESCRIPTION

Acrylic pressure sensitive adhesives are well-known. Typically, acrylic pressure sensitive adhesive comprise the polymerization product of a monomer mixture comprising one or more (meth)acrylate ester and optionally, one or more vinyl carboxylic acids. Depending on the desired properties, other copolymerizable monomers may also be included in the monomer mixture.

As used herein, “(meth)acrylate” refers to one and/or both the acrylate ester and the methacrylate ester. Thus, for example, butyl (meth)acrylate refers to butyl acrylate and/or butyl methacrylate.

In some embodiments, at least one (meth)acrylate ester is an alkyl(meth)acrylate. In some embodiments, the alkyl group of at least one alkyl(meth)acrylate contains 5 to 18 carbon atoms, e.g., 5 to 12 carbon atoms. In some embodiments, the alkyl group of at least one alkyl(meth)acrylate contains 8 carbon atoms, e.g., isooctyl (meth)acrylate and 2-ethylhexyl (meth)acrylate. In some embodiments, the alkyl group of at least one alkyl(meth)acrylate contains 1 to 4 carbon atoms, e.g., butyl (meth)acrylate. In some embodiments, the alkyl group of at least one alkyl(meth)acrylate contains 1 to 3 carbon atoms, e.g., 2 carbon atoms.

In some embodiments, the monomer mixture includes one or more vinyl carboxylic acids. Generally, any known vinyl carboxylic acid or mixture of vinyl carboxylic acids may be used. Exemplary vinyl carboxylic acids include acrylic acid, methacrylic acid, itaconic acid, maleic acid, fumaric acid, and β-carboxyethylacrylate. In some embodiments, the vinyl carboxylic acid may be selected from the group consisting of acrylic acid, methacrylic acid, and combinations thereof.

In some embodiments, it may be desirable to include one or more non-polar monomers. As used herein, a “non-polar” monomer is a monomer whose homopolymer has a solubility parameter as measured by the Fedors' method of no greater than 10.5. Examples of suitable non-polar monomers and their Fedors' solubility parameter ((cal/cm³)^{1/2}) include 3,3,5 trimethylcyclohexyl acrylate (9.35), isobornyl acrylate (9.71), butyl acrylate (9.77), cyclohexyl acrylate (10.16), and N-octyl acrylamide (10.33).

In some embodiments, the monomer mixture comprises at least 80 weight percent (wt. %) e.g., at least 90 wt. %, at least 95 wt. % or even at least 98 wt. % of the one or more alkyl (meth)acrylate monomers. In some embodiments, the monomer mixture comprises no greater than 10 wt. %, e.g., no greater than 8 wt. %, no greater than 5 wt. %, no greater than 2 wt. % or even no greater than 1 wt. % of the vinyl carboxylic acid monomers. In some embodiments, the monomer mixture comprises 0 to 4 wt. %, for example 0.1 to 4 wt. %, 0.1 to 2 wt. %, 0.1 to 1 wt. %, or even 0.1 to 0.5 wt. % of the vinyl carboxylic acid monomers. In other embodiments, the monomer mixture comprises at least 3 wt. %, e.g., at least 5 wt. % of the vinyl carboxylic acid monomers, e.g., 3 to 10 wt. %, or 5 to 10 wt. %, of the vinyl carboxylic acid monomers.

The pressure sensitive adhesives of the present disclosure also include at least one cyclic phosphonate flame retardant. Exemplary cyclic phosphonate esters suitable for use as flame retardants in the adhesive compositions of the present disclosure include those described in, e.g., U.S. Pat. Nos. 3,789,091 and 3,849,368, as well as those available from Rhodia under the tradename AMGARD (e.g., AMGARD CU, and AMGARD 1045). Suitable cyclic phosphonates include those having the general structure of Formula 1:

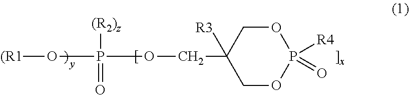

wherein R1 and R2 are independently selected from the group consisting of a C1 to C8 alkyl and a phenyl, wherein the alkyl and/or phenyl group may be substituted with at least one hydroxyl, hydroxyalkyl, or phenoxyalkyl, group;

R3 and R4 are independently selected from the group consisting of C1 to C4 alkyl;

x is 1, 2, or 3;

y is 0, 1, or 2; and

z is 0 or 1;

wherein the sum of x, y, and z is equal to 3.

Specific, exemplary cyclic phosphonates of Formula 1 include

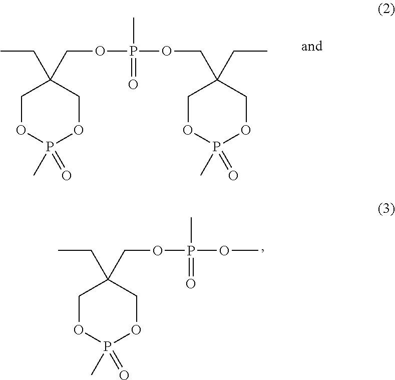

as well as dimmers and trimers of such materials, including those with longer aliphatic chains instead of methyl groups. Mixtures of such materials may also be used.

Other suitable cyclic phosphonate esters include those having the general Formula 4:

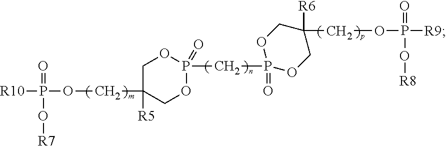

wherein R5 and R6 are independently selected from the group consisting of C1 to C4 alkyl groups;

R7, R8, R9, and R10 are independently selected from the group consisting of a C1 to C8 alkyl and a phenyl, wherein the alkyl and/or phenyl group may be substituted with at least one hydroxyl, hydroxyalkyl, or phenoxyalkyl, group;

n is 0 to 6;

m is 0 to 8; and

p is 0 or 8.

Specific, exemplary cyclic phosphonates of Formula 4 include

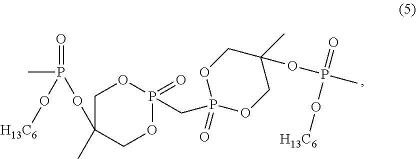

as well as dimmers and trimers of such materials, including those with longer aliphatic chains instead of methyl groups. Mixtures of such materials, alone or in combinations with cyclic phosphonates of Formula 1 may also be used.

In addition to the acrylic adhesive and the flame retardant, the pressure sensitive adhesive compositions of the present disclosure may include any of a wide variety of know additives including, e.g., crosslinkers, initiators, fillers, tackifiers, dyes, pigments, and the like. The selection and relative amounts of such materials will depend on the desired end-use characteristics, as is well-understood by one of ordinary skill in the art.

### EXAMPLES

TABLE 1
Materials used in the examples.

| I.D. | Description | Source |
|---|---|---|
| SB-ADH-1 | 90:10 (IOA:AA)^{(a)} acrylic adhesive | 3M Company |
| | (41 wt. % in a acetone, naptha, and | St. Paul, MN |
| | hydrotreated naptha) | |
| SB-ADH-2 | 90:10 (IOA:AA) acrylic adhesive | 3M Company |
| | (15 wt. % in ethylacetate and toluene) | |
| UV-ADH-1 | 90:10 (IOA:AA) prepolymerized syrup | 3M Company |
| UV-ADH-2 | 90:10 (IOA:AA) prepoylmerized syrup | 3M Company |
| HM-ADH-1 | 90:10 (IOA:AA) acrylic adhesive | 3M Company |
| HM-ADH-2 | 90:10 (2-EHA:AA) acrylic adhesive | 3M Company |
| HM-ADH-3 | 90:10 (2-EHA:AA) acrylic adhesive | 3M Company |
| | with an ionic crosslinker | |
| CP-FR-1 | Cyclic phosphonate flame retardant | Rhodia |
| | (AMGARD CU)^{(b)} | |
| CP-FR-2 | Cyclic phosphonate flame retardant | Rhodia |
| | (AMGARD 1045)^{(b)} | |
| CP-FR-3 | Cyclic phosphonate flame retardant | Rhodia |
| | (AMGARD SPDH)^{(c)} | |
| FR-4 | Arylphosphate flame retardant | ICL |
| | (FYROL A710) | |
| FR-5 | Phosphororganic salt | Clariant |
| | (EXOLIT OP935) | |
| FR-6 | Aluminumtrihydrate (“ATH”) | Nabaltec |
| | (APYRAL 24) | |
| FR-7 | Vinylphosphonatedimethylester | BASF |
| | (CAS 4685-32-3) | |
| FR-8 | 3,4:5,6-Dibenzo-1,2-oxaphosphane-2- | TCI Europe |
| | oxide | |
| HDDA | 1,6-Hexanediol diacrylate crosslinker | |
| IR-651 | 2,2-Dimethoxy-1,2-diphenylethan-1-one | Ciba Specialty |
| | (IRGACURE 651 photoinitiator) | Chemicals, Inc. |

^{(a)}IOA = isooctyl acrylate; 2-EHA = 2-ethylhexyl acrylate; AA = acrylic acid
^{(b)}AMGARD CU and 1045 flame retardants are a blend of the cyclic phosphonates illustrated by Formulas (2) and (3).
^{(c)}AMGARD SPDH is a cyclic phosphonate ester illustrated by Formula (4).

Test Methods

Horizontal Burn Procedure. Samples were evaluated according to the Federal Motor Vehicle Safety Standard No. 302 (“Flammability of Interior Materials”), (FMVSS302) test procedure. The results were rated as follows:

| Rating | Description |
|---|---|
| DNI | Sample does not ignite |
| SE | Sample extinguishes before the start mark |
| SENBR | Sample extinguishes within 8.9 cm of the start mark |
| SEB | Sample extinguishes after 8.9 cm from the start mark, |
| | but before the end of the sample (burn rate (mm/min)) |
| B | Sample burns to the end (burn rate (mm/min)) |

Vertical Burn Procedure. Samples were tested according Underwriters Laboratory Standard UL94. Generally, a 12.7 cm long by 1.27 cm wide sample was suspended vertically 10 mm above the burner and 30.5 cm above the cotton. A 20 mm high flame was applied to the free end of the sample at 45° angle for ten seconds and then removed until the flaming stops. The flame was reapplied for another ten seconds and again removed until the flaming stops. The results were rated as follows:

| Rating | Description |
|---|---|
| V0 | Burning stops within 10 seconds after each application of flame; |
| | drips of particles allowed as long as they do not ignite the cotton |
| V1 | Burning stops within 30 seconds after each application of flame; |
| | drips of particles allowed as long as they do not ignite the cotton |
| V2 | Burning stops within 30 seconds after each application of flame; |
| | drips of flaming particles that ignite the cotton are allowed |

180 Degree Peel tests were conducting according to FINAT Test Method No. 1 (FTM 1, “Peel adhesion (180°) at 300 mm per minute,” FINAT Technical Handbook 7th edition, 2005).

Static Shear tests were conducting according to FINAT Test Method No. 8 (FTM 8, “Resistance to shear from a standard surface,” FINAT Technical Handbook 7th edition, 2005).

Dynamic Shear tests were conducting according to FINAT Test Method No. 18 (FTM 18, “Dynamic Shear,” FINAT Technical Handbook 7th edition, 2005).

Solvent Based Adhesives. The desired solvent based adhesive (SB-ADH-1 or SB-ADH-2) was combined with 0.2 to 0.5 wt. % of a bisaziridine crosslinker and a flame retardant. The resulting composition was coated onto a release liner and sent through an oven. Here, the solvent was removed and the adhesive was thermally crosslinked to produce a 44 micrometer thick adhesive film.

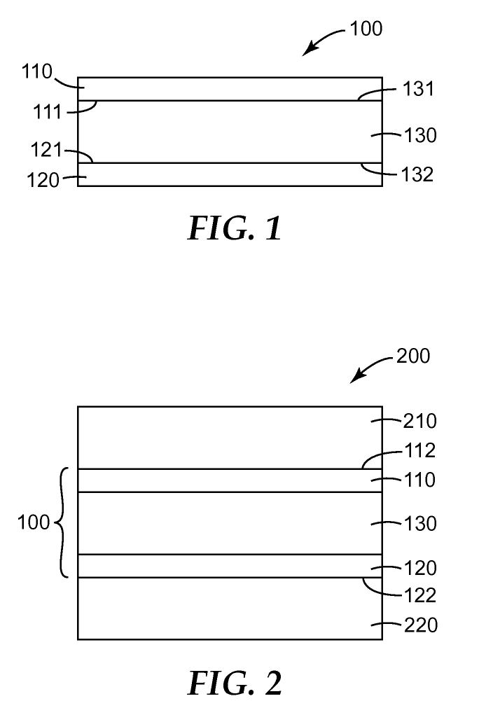

Spacer. Two such adhesive films were laminated to opposite sides of a 12 micrometer thick polyester (PET) carrier film (MYLAR LBT2, from DuPont Teijin) to produce a “spacer” tape. Spacer tape 100 is illustrated in FIG. 1. First adhesive layer 110 comprises first surface 111 adhered to first surface 131 of carrier 130. Similarly, first surface 121 of second adhesive layer 120 is adhered to second surface 132 of carrier 130.

Sandwich. Samples were also prepared by laminating a 175 micrometer thick cover layer of PET to each of the first and second adhesive layers. As illustrated in FIG. 2, “sandwich” construction 200, comprises spacer tape 100. First cover layer 210 is adhered to second surface 112 of first adhesive layer 110. Similarly, second cover layer 220 is adhered to second surface 122 of second adhesive layer 120.

Neither the PET carrier film nor the PET cover films contained any flame retardant. Thus, all flame retardant characteristics are provided by flame retardant in the two adhesive layers.

These samples were subjected to the Horizontal Burn Procedure. The results are reported in Table 2. A commercially available sample (3M™ Double Linered Adhesive Transfer Tape 9553, from 3M Company) was also tested, and is identified as “REF-1.”

TABLE 2
Horizontal burn tests (FMVSS302) results for solvent based adhesives.

| | | | | | | Burn |
|---|---|---|---|---|---|---|
| | | | | wt. | | Speed |
| | Base | Sample | Flame | % | | (mm/ |
| Example | Adhesive | type | Retardant | FR | Rating | min) |
| CE-1 | SB-ADH-2 | Spacer | none | 0 | B | 268 |
| EX-1 | SB-ADH-2 | Spacer | CP-FR-1 | 5 | SE | N/A |
| EX-2 | SB-ADH-2 | Spacer | CP-FR-1 | 10 | SE | N/A |
| EX-3 | SB-ADH-2 | Sandwich | CP-FR-1 | 10 | SE | N/A |
| CE-2 | SB-ADH-1 | Spacer | none | 0 | B | 265 |
| EX-4 | SB-ADH-1 | Spacer | CP-FR-1 | 5 | SE | N/A |
| EX-5 | SB-ADH-1 | Spacer | CP-FR-1 | 10 | SE | N/A |
| EX-6 | SB-ADH-1 | Sandwich | CP-FR-1 | 10 | SE | N/A |
| EX-7 | SB-ADH-1 | Spacer | CP-FR-2 | 5 | SE | N/A |
| EX-8 | SB-ADH-1 | Spacer | CP-FR-2 | 10 | SE | N/A |
| EX-9 | SB-ADH-1 | Spacer | CP-FR-3 | 5 | SE | N/A |
| EX-10 | SB-ADH-1 | Spacer | CP-FR-3 | 10 | SE | N/A |
| EX-11 | SB-ADH-2 | Sandwich | CP-FR-3 | 10 | SE | N/A |
| EX-12 | SB-ADH-1 | Sandwich | CP-FR-3 | 10 | SE | N/A |
| CE-3 | SB-ADH-1 | Spacer | FR-5 | 10 | B | 518 |
| CE-4 | SB-ADH-1 | Spacer | FR-5 | 20 | B | 318 |
| CE-5 | SB-ADH-1 | Spacer | FR-5 | 30 | SE | N/A |
| CE-6 | SB-ADH-1 | Spacer | FR-4 | 5 | B | 202 |
| CE-7 | SB-ADH-1 | Spacer | FR-4 | 10 | SE | N/A |
| CE-8 | SB-ADH2 | Spacer | FR-8 | 5 | B | 365 |
| CE-9 | SB-ADH2 | Spacer | FR-8 | 10 | B | 346 |
| REF-1 | acrylic | Spacer | none | 0 | B | 492 |

The solvent based adhesive constructions were also evaluated to determine the effect of flame retardant loading on pressure sensitive adhesive properties. The samples were evaluated according to the 180 Degree Peel test (“180° Peel”), the Static Shear test at 20-22° C., and the Dynamic Shear test at 85° C. The results are summarized in Table 3.

TABLE 3
Pressure sensitive adhesive performance for solvent based adhesives.

| | Base | Sample | Flame | wt. % | 180° Peel | Static Shear | Dynamic |
|---|---|---|---|---|---|---|---|
| Ex. | Adhesive | type | Retardant | FR | (N/cm) | (min.) | Shear (min.) |
| CE-1 | SB-ADH-2 | Spacer | none | 0 | 4.4 | 5000+ | 32.4 |
| EX-1 | SB-ADH-2 | Spacer | CP-FR-1 | 5 | N.T. | 5000+ | 29.5 |
| EX-2 | SB-ADH-2 | Spacer | CP-FR-1 | 10 | 5.1 | 5000+ | 18.4 |
| CE-2 | SB-ADH-1 | Spacer | none | 0 | 3.9 | 10000+ | 22.1 |
| EX-4 | SB-ADH-1 | Spacer | CP-FR-1 | 5 | N.T. | N.T | 21.1 |
| EX-5 | SB-ADH-1 | Spacer | CP-FR-1 | 10 | 5.1 | 10000+ | 13.7 |
| EX-8 | SB-ADH-1 | Spacer | CP-FR-2 | 10 | 5.1 | 10000+ | N.T. |

N.T. = Not tested

Solventless UV-Cured Adhesive Samples. The desired solventless acrylic adhesive prepolymer (UV-ADH-1 or UV-ADH-2) was blended with 0.12 wt. % HDDA crosslinker, 0.2 wt. % IR-651 photoinitiator, and a flame retardant. The UV-ADH-1 adhesive was coated onto a release liner and passed through an ultraviolet curing station to form a 44 micrometer thick cured acrylic adhesive film. Two such films of UV-ADH-1 adhesive were laminated to opposite sides of the 12 micrometer PET carrier film to form a “spacer” construction. (See FIG. 1.) The UV-ADH-2 adhesive was coated onto a release liner and passed through an ultraviolet curing station to form a 1000 micrometer thick cured acrylic adhesive film, which was tested as is (“Thick” construction).

Samples prepared from the solventless, UV-cured, acrylic adhesives were tested for flammability according to the Horizontal Burn Procedure. The results are reported in Table 4. Samples were also tested for adhesive performance according to the 90 Degree Peel (“90° Peel”) Procedure and the Static Shear Procedure at both 20-22° C. and 75° C. The results are reported in Table 5.

TABLE 4
Horizontal burn tests (FMVSS302) results for solventless,
UV-cured adhesives.

| | | | | | | Burn |
|---|---|---|---|---|---|---|
| | | | | Wt. | | Speed |
| | Base | Sample | Flame | % | | (mm/ |
| Example | Adhesive | type | Retardant | FR | Rating | min) |
| EX-13 | UV-ADH-1 | Spacer | CP-FR-1 | 5 | SE | N/A |
| EX-14 | UV-ADH-1 | Spacer | CP-FR-1 | 10 | SE | N/A |
| CE-10 | UV-ADH-2 | Thick | none | 0 | B | 75 |
| EX-15 | UV-ADH-2 | Thick | CP-FR-1 | 5 | SE | N/A |
| EX-16 | UV-ADH-2 | Thick | CP-FR-1 | 10 | SE | N/A |
| EX-17 | UV-ADH-2 | Thick | CP-FR-1 | 20 | SE | N/A |
| CE-11 | UV-ADH-2 | Thick | FR-7 | 10 | B | 102 |
| CE-12 | UV-ADH-2 | Thick | FR-7 | 15 | SE | N/A |
| REF-2 | UV-ADH-2 | Thick | none | 0 | SE | N/A |

TABLE 5
Pressure sensitive adhesive performance for solventless, UV-cured adhesives.

| | | | | | | Static Shear | |
|---|---|---|---|---|---|---|---|
| | Base | Sample | Flame | wt. % | 90° Peel | 20-22° C. | 75° C. |
| Ex. | Adhesive | type | Retardant | FR | (N/cm) | (min.) | (min.) |
| CE-10 | UV-ADH-2 | Thick | none | 0 | 28.0 | 10000+ | 10000+ |
| EX-15 | UV-ADH-2 | Thick | CP-FR-1 | 5 | 23.2 | 1835 | 109 |
| EX-16 | UV-ADH-2 | Thick | CP-FR-1 | 10 | 22.2 | 388 | 33 |
| EX-17 | UV-ADH-2 | Thick | CP-FR-1 | 20 | 18.5 | 53 | 7 |
| CE-11 | UV-ADH-2 | VHB | FR-7 | 10 | 20.0 | 612 | 57 |
| CE-12 | UV-ADH-2 | VHB | FR-7 | 15 | 24.4 | 7563 | 60 |
| REF-2 | UV-ADH-2 | VHB | none | 0 | 24.4 | 7563 | 318 |

Various amounts of the CP-FR-1 cyclic phosphonate flame retardant were combined with the UV-ADH-2 solventless, UV-cured adhesive. Thick (1000 microns) samples were prepared and tested according to the Vertical Burn Procedure. The results are summarized in Table 6.

TABLE 6
Vertical burn tests (UL94) results for VHB samples prepared
using the UV-ADH-2 solventless, UV-cured adhesives with
the CP-FR-1 cyclic phosphonate flame retardant.

| | wt. % | Dripping | UL94 | UL94 |
|---|---|---|---|---|
| Ex. | FR | UL94-V | (VTM) | (V) |
| EX-18 | 10 | FDIC | VTM-0 | Fail |
| EX-19 | 15 | DNF | VTM-0 | V-0 |
| EX-20 | 20 | DNF | VTM-0 | V-0 |
| EX-21 | 30 | DNF | N/T | V-1 |

Hot Melt Coated Adhesives. Adhesive films were prepared by hot melt coating a blend of the desired adhesive (HM-ADH-1, HM-ADH-2, or HM-ADH-3) and a flame retardant to produce a 44 micrometer thick layer of acrylic adhesive. These adhesive films were combined with the 12 micrometer PET carrier to form a spacer construction. (See FIG. 1.) Additional 175 micrometer PET cover films were added to provide sandwich constructions. (See FIG. 2.)

The resulting hot melt adhesive samples were evaluated according to the Horizontal Burn Procedure, and the results are reported in Table 7. Reference sample REF-1, was also tested. Adhesive properties were also tested at both 20-22° C. and 85° C. The results of the 180 Degree Peel test, the Static Shear test, and the Dynamic Shear test are summarized in Table 8.

TABLE 7
Horizontal burn tests (FMVSS302) results for hot melt adhesives.

| | | | | | | Burn |
|---|---|---|---|---|---|---|
| | | | | | | Speed |
| | Base | Sample | Flame | wt. % | | (mm/ |
| Ex. | Adhesive | type | Retardant | FR | Rating | min) |
| EX-22 | HM-ADH-1 | Spacer | CP-FR-1 | 10 | DNI | N/A |
| EX-23 | HM-ADH-1 | Sandwich | CP-FR-1 | 10 | SE | N/A |
| EX-24 | HM-ADH-2 | Spacer | CP-FR-1 | 10 | DNI | N/A |
| EX-25 | HM-ADH-2 | Sandwich | CP-FR-1 | 10 | SE | N/A |
| EX-26 | HM-ADH-3 | Spacer | CP-FR-1 | 10 | DNI | N/A |
| EX-27 | HM-ADH-3 | Sandwich | CP-FR-1 | 10 | SE | N/A |
| EX-28 | HM-ADH-3 | Spacer | CP-FR-1 | 7.5 | DNI | N/A |
| EX-29 | HM-ADH-3 | Sandwich | CP-FR-1 | 7.5 | SE | N/A |
| EX-30 | HM-ADH-3 | Spacer | CP-FR-1 | 5 | SE | N/A |
| EX-31 | HM-ADH-3 | Sandwich | CP-FR-1 | 5 | SE | N/A |
| REF-1 | acrylic | Spacer | none | 0 | B | 492 |

TABLE 8
Pressure sensitive adhesive performance for hot melt adhesives.
(all samples contained 10 wt. % CP-FR-1 flame retardant)

| | | | 180 Degree | | Static Shear | | Dynamic | |
|---|---|---|---|---|---|---|---|---|
| | Ad- | | Peel (N/cm) | | (min) | | Shear (min) | |
| Ex. | hesive | Sample | RT | HT | RT | HT | RT | HT |
| EX-22 | HM- | Spacer | 5.8 | 3.7 | 10000+ | 53 | 374 | 30 |
| | ADH-1 | | | | | | | |
| EX-24 | HM- | Spacer | 5.9 | 3.8 | 10000+ | 106 | 365 | 38 |
| | ADH-2 | | | | | | | |
| REF-1 | acrylic | Spacer | 4.8 | 3.0 | 10000+ | 1218 | 307 | 67 |

RT = 20-22° C.;
HT = 85° C.

The flame retardant pressure sensitive adhesives of the present disclosure may be used in a wide variety of applications, e.g., as free films, supported films, and single and double-sided tapes. Free films of adhesive may be disposed on a substrate such as a release liner, or may be located between two release liners. Supported films include adhesive layers incorporating any of a wide variety of well known supports such as scrims, woven and non-woven webs comprising organic and/or inorganic fibers, paper, and the like.

Tapes typical comprise a substrate with a layer of adhesive on one side (i.e., a single-coated tape) or on opposite sides (i.e., a double coated tape). Any of a wide variety of known substrates, including, e.g., those comprising papers, films (e.g., polymeric films), and foils, may be used. In some embodiments, the substrate may comprise a foam, e.g., an adhesive foam. Generally, the adhesive on the opposite sides a double-sided tape are independently selected. In some embodiments, both adhesives may comprise a flame retardant adhesive according to the present disclosure. In some embodiments, only one of the adhesive may comprise a flame retardant adhesive according to the present disclosure. In such embodiments, the second adhesive may be any known adhesive including known flame retardant, and non-flame retardant adhesives.

Various modifications and alterations of this invention will become apparent to those skilled in the art without departing from the scope and spirit of this invention.

1. A flame retardant pressure sensitive adhesive comprising a polymeric component comprising an acrylic pressure sensitive adhesive and a flame retardant comprising at least one cyclic phosphonate ester, wherein the flame retardant comprises less than 2 parts by weight of a phosphorous containing flame retardant other than the cyclic phosphonate ester, wherein the total amount of flame retardant is between 3 and 15 parts by weight, inclusive, per 100 parts by weight of the polymeric component.

2-3. (canceled)

4. The flame retardant pressure sensitive adhesive of claim 1, wherein the total amount of flame retardant is between 3 and 6 parts by weight, inclusive, per 100 parts by weight of the polymeric component.

5. A flame retardant pressure sensitive adhesive comprising a polymeric component comprising an acrylic pressure sensitive adhesive and a flame retardant comprising at least one cyclic phosphonate ester, wherein the total amount of cyclic phosphonate ester is no greater than 6 parts by weight per 100 parts by weight of the polymeric component.

6. The flame retardant pressure sensitive adhesive of claim 5, wherein the total amount of cyclic phosphonate ester is between 3 and 6 parts by weight, inclusive, per 100 parts by weight of the polymeric component.

7. The flame retardant pressure sensitive adhesive according to claim 1, wherein the flame retardant comprises at least one first cyclic phosphonate ester having the formula: 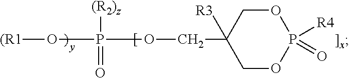
wherein R1 and R2 are independently selected from the group consisting of a C1 to C8 alkyl and a phenyl, wherein the alkyl and/or phenyl group may be substituted with at least one hydroxyl, hydroxyalkyl, or phenoxyalkyl, group;
R3 and R4 are independently selected from the group consisting of C1 to C4 alkyl;
x is 1, 2, or 3;
y is 0, 1, or 2; and
z is 0 or 1;
wherein the sum of x, y, and z is equal to 3.

8. The flame retardant pressure sensitive adhesive according to claim 7, wherein the first cyclic phosphonate ester is selected from the group consisting of: 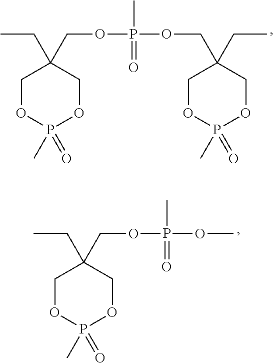
and combinations thereof.

9. The flame retardant pressure sensitive adhesive according to claim 1, wherein the flame retardant comprises at least one second cyclic phosphonate ester having the formula: 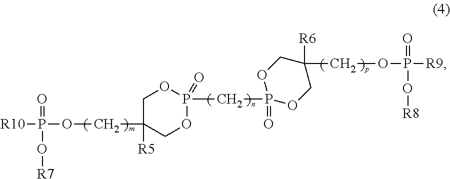
wherein R5 and R6 are independently selected from the group consisting of C1 to C4 alkyl groups;
R7, R8, R9, and R10 are independently selected from the group consisting of a C1 to C8 alkyl and a phenyl, wherein the alkyl and/or phenyl group may be substituted with at least one hydroxyl, hydroxyalkyl, or phenoxyalkyl, group;
n is 0 to 6;
m is 0 to 8; and
p is 0 or 8.

10. The flame retardant pressure sensitive adhesive according to claim 9, wherein the second cyclic phosphonate ester is:

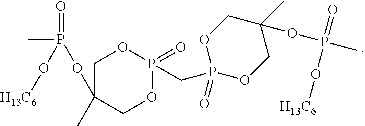

11. An adhesive article comprising a first substrate and a first adhesive adhered to a first major surface of the first substrate, wherein the first adhesive comprises the flame retardant pressure sensitive adhesive according to claim 1.

12. The adhesive article of claim 11, further comprising a second adhesive adhered to a second major surface of the first substrate opposite the first major surface of the first substrate, wherein the second adhesive comprises the flame retardant pressure sensitive adhesive according to any one of claims 1 to 10, and wherein the first adhesive and the second adhesive are independently selected.

13. The adhesive article of claim 11, further comprising a second substrate adhered to the first adhesive such that the first adhesive is located between the first substrate and the second substrate.

14. The adhesive article according to claim 1, wherein the first substrate comprises a foam.

15. The adhesive article of claim 14, wherein the foam comprises an adhesive.
